(19) United States
(12) Patent Application Publication
(10) Pub. No.: US 2003/0050925 A1
(43) Pub. Date: Mar. 13, 2003

(54) Tree search unit

(76) Inventors: Reuven Moskovich, Tel-Aviv (IL); Eliezer Levy, Haifa (IL)

Correspondence Address: William H. Dippert, Esq., Reed Smith LLP, 29th Floor, 599 Lexington Avenue, New York, NY, 10022-7650, US

(21) Appl. No.: 10/224,713

(22) Filed: Aug. 20, 2002

(30) Foreign Application Priority Data
Aug. 21, 2001 (IL) 145040

(51) Int. Cl. G06F 7/00

(52) U.S. Cl. 707/3

(57) ABSTRACT

A hardware unit for searching through a tree. The hardware unit includes a memory which stores a plurality of records, which describe the tree, an input interface adapted to receive an input string to be searched for in the tree and a hardware controller, which does not store an internal state, other than an optional position in the input string, adapted to determine a pointer related to the input string, if such a pointer exists.

### FIELD OF THE INVENTION

The present invention relates to data storage access systems and particularly to tree search systems.

### BACKGROUND OF THE INVENTION

Tree data structures are often used to store information in databases. For example, tree data structures are used to store information which is referenced by a string key field. The tree is formed of a plurality of nodes, which are connected by links in a manner that defines paths of progression in the tree. The links of a tree do not form a loop that allows progression in a circular path. The tree generally includes a root node which is a starting point of the tree. Each node is connected to a link which leads towards the root. The node to which the link leading to the root is connected, is referred to as a parent node. Nodes connected to links leading away from the root, are referred to as child nodes. Two nodes which have a common parent node are referred to as peer nodes.

In an exemplary tree data structure that stores string key fields, each node in the tree represents a character in the string. In order to find a string in the tree, progression begins from a root node in search of child nodes that represent the next character in the string. A node representing a last character in a string, generally includes one or more pointers to data records related to the specific string.

Unlike searches through regular databases, tree searches require keeping track of the values of a plurality of nodes and progressing through the tree, in determining a match. Therefore, tree searches are generally performed by general purpose processors.

### SUMMARY OF THE INVENTION

An aspect of some embodiments of the present invention relates to a dedicated hardware unit for searching through a tree. The term hardware unit refers to a dedicated machine which is used substantially only for a specific task.

In some embodiments of the invention, the hardware unit comprises a μ-sequencer including a controller and a memory, which memory stores records that represent the tree. Optionally, each record represents a node in the tree. The operations performed by the controller are optionally determined responsive to the contents of a record from the memory and/or one or more inputs of the hardware unit. In some embodiments of the invention, the controller does not include internal state registers which determine the operations performed by the controller, except possibly a counter pointing to a position in an input string searched for in the tree. In some embodiments of the invention, the controller does not execute multi-bit commands and/or predetermined memory-stored commands. Optionally, the only data, used by the controller, stored in the memory is the records representing the tree. In the art, μ-sequencers are generally used as controllers of application specific integrated circuits (ASICs).

Optionally, all the nodes of the tree are represented by records of the same length including the same field division, in order to allow easy access by the hardware unit. The hardware unit transverses through the tree, retrieving records and determining whether they match an input string. In some embodiments of the invention, the contents of each record are used in determining the next record to be loaded into the hardware unit. In some embodiments of the invention, each record represents a node of the tree.

There is therefore provided in accordance with an embodiment of the present invention, a hardware unit for searching through a tree, comprising a memory which stores a plurality of records, which describe the tree, an input interface adapted to receive an input string to be searched for in the tree, and a hardware controller, which does not store an internal state, other than an optional position in the input string, adapted to determine a pointer related to the input string, if such a pointer exists.

Optionally, the controller does not receive multi-bit commands and/or memory-stored commands. Optionally, the plurality of records stored in the memory have the same length and field division. Optionally, the controller determines a pointer corresponding to a string represented by the tree, which is identical to the input string. Optionally, the controller determines a pointer corresponding to a largest sub-string of the input string that has a corresponding external pointer. Optionally, except for a first record of the tree the controller fetches records from the memory using addresses contained in previously fetched records.

Optionally, the controller comprises a multiplexer which provides addresses of records to be fetched from the tree and wherein the multiplexer has not more than four different input lines from which the addresses are selected.

Optionally, the records include up to two pointer fields pointing to other records. In some embodiments, the records include a child pointer field and a next record field, pointing to a record having a common parent with the record including the next record field. Optionally, the records include up to three pointer fields to other records or to external points.

### BRIEF DESCRIPTION OF FIGURES

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a tree search unit, in accordance with an embodiment of the present invention;

FIG. 2 is a schematic illustration of a tree with exemplary values, which may be searched in accordance with an embodiment of the present invention;

FIG. 3 is a schematic illustration of a tree database, in accordance with an embodiment of the present invention; and

FIG. 4 is a schematic illustration of a controller of a tree search unit, in accordance with an embodiment of the present invention.

### DETAILED DESCRIPTION OF EMBODIMENTS

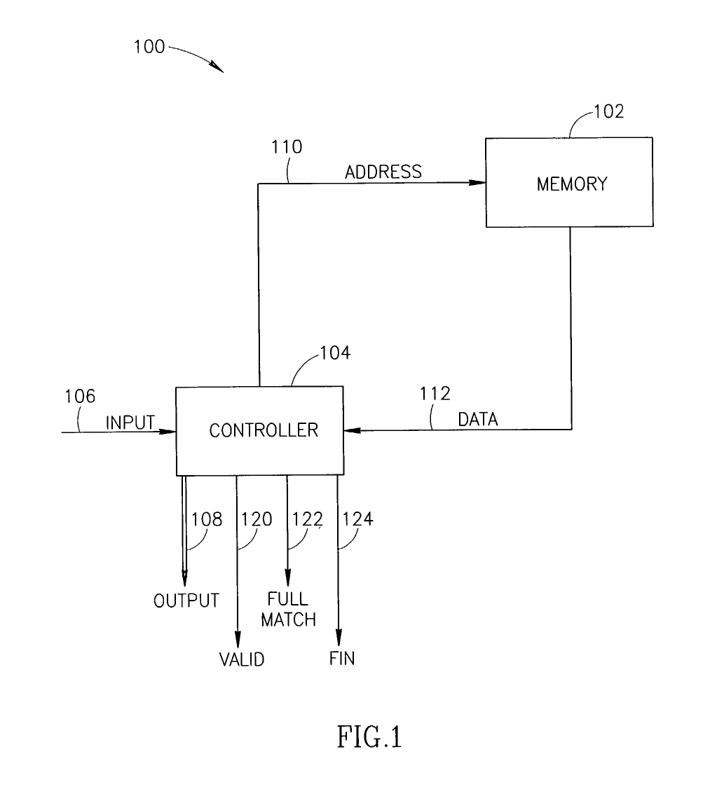

FIG. 1 is a schematic illustration of a μ-sequencer 100 for tree searches, in accordance with an embodiment of the present invention. μ-sequencer 100 comprises a memory 102 that stores records which represent a tree database and a control machine, referred to herein as a controller 104. Memory 102 optionally comprises a fast memory unit with a short delay in providing data. Each record optionally comprises one or more fields which include pointers to other records of the tree. Controller 104 receives an input string (i.e., a sequence of one or more characters of the alphabet of the tree) on an input line 106, searches through the database tree and provides an output pointer to the result on an output line 108. In some embodiments of the invention, controller 104 also provides an output pointer valid signal, which indicates that output line 108 is valid, on a valid line 120. Optionally, a fin line 124 indicates that the search ended. Alternatively or additionally, assertion of valid line 120 also indicates the end of the search.

In some embodiments of the invention, the pointer provided on output line 108 points to the record corresponding to the longest sub-string in the input string, for which a record exists in the database. In these embodiments, controller 104 optionally provides, on a full match line 122, a full match signal that indicates whether the pointer on output line 108 matches the input string or a sub-string of the input string. Alternatively, the pointer provided on output line 108 points to a record corresponding to the input string, and if such a string is not found a predetermined null string is provided.

The search through the database is optionally performed by traveling through the tree using the pointers in the records, and optionally other information in the records. In some embodiments of the invention, controller 104 provides memory 102 with pointers to records in the memory, over an address bus 110 and receives the addressed records from memory 102 over a data bus 112.

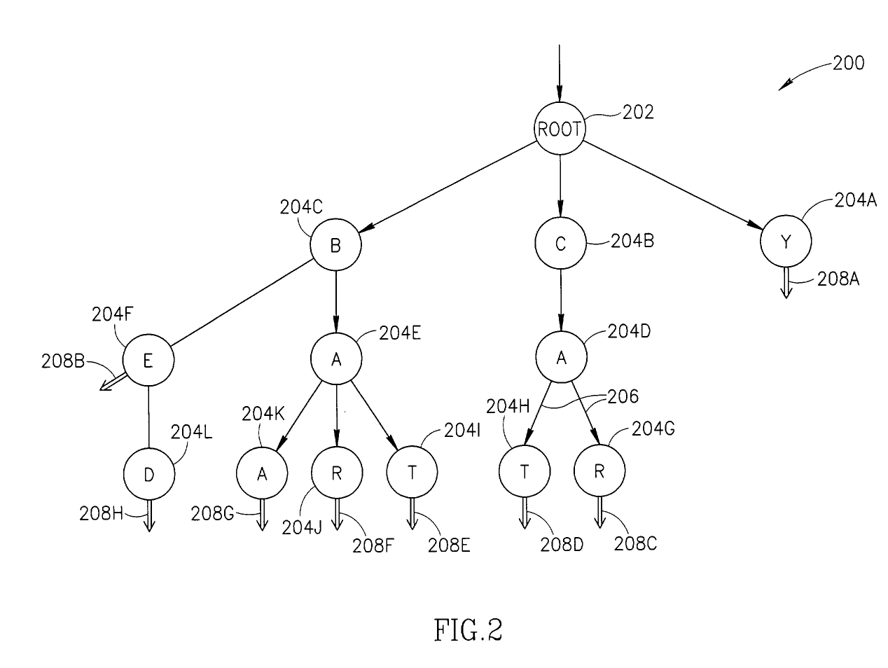

FIG. 2 is a schematic illustration of a tree 200 with exemplary values, which may be searched in accordance with an embodiment of the present invention. Tree 200 comprises a root node 202 at which searches begin and a plurality of nodes 204 (marked 204A, 204B, etc.) which represent alphabet characters. Links 206 connect parent nodes to their child nodes. In some embodiments of the invention, pointers 208 lead from nodes 204, completing a valid string in tree 200, to a record containing data relating to the string. It is noted that the alphabet characters may belong to substantially any group of symbols, including letters, digits, words and numbers. The characters of the alphabet may be ordered or non-ordered.

In some embodiments of the invention, the child nodes in tree 200 are not sorted, i.e., the child nodes of a specific node are not organized in an order determined according to their value. Alternatively, the child nodes in tree 200 are sorted.

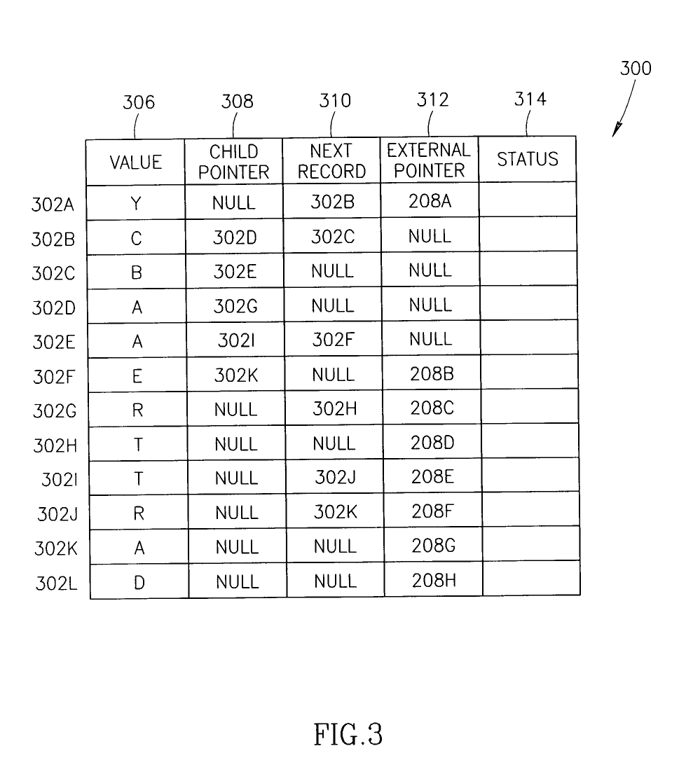

FIG. 3 is a schematic illustration of a tree database 300 in memory 102, in accordance with an embodiment of the present invention. Tree database 300 includes a plurality of records 302 (marked 302A, 302B, etc.) which represent respective nodes 204 of a tree. For clarity, records 302A, 302B, etc., correspond to nodes 208A, 208B, etc. In some embodiments of the invention, all of records 302 have the same length to allow simple standard manipulation of records 302 by controller 104 (FIG. 1). In some embodiments of the invention, each record 302 comprises a value field 306, which includes a value of the node 204 represented by the record. Each record 302 optionally comprises a child pointer field 308 which includes the memory address of a record 302 which represents a child node of the node represented by the record.

In some embodiments of the invention, each record 302 further comprises a next record field 310 which includes a pointer (e.g., memory address) to another record, representing a peer node (i.e., another node having the same parent node). Optionally, the records 302 representing peer nodes 204 having a common parent node are organized in a predetermined order. For example, the predetermined order may be according to their values, according to the time at which they were created and/or random. The first node in the predetermined order is referenced by the child pointer field 308 of the parent node. The other nodes in the predetermined order are each referenced by the next record field 310 of the previous node in the predetermined order. The record representing the last node in the predetermined order optionally has a null value in next record field 310.

In some embodiments of the invention, each record 302 includes an external pointer field 312, which carries a pointer (208, FIG. 2) to an external record relating to the string represented by a path of nodes ending in the node represented by the record 302, if such an external record exists. If such an external pointer does not exist, external pointer field 312 has a null value.

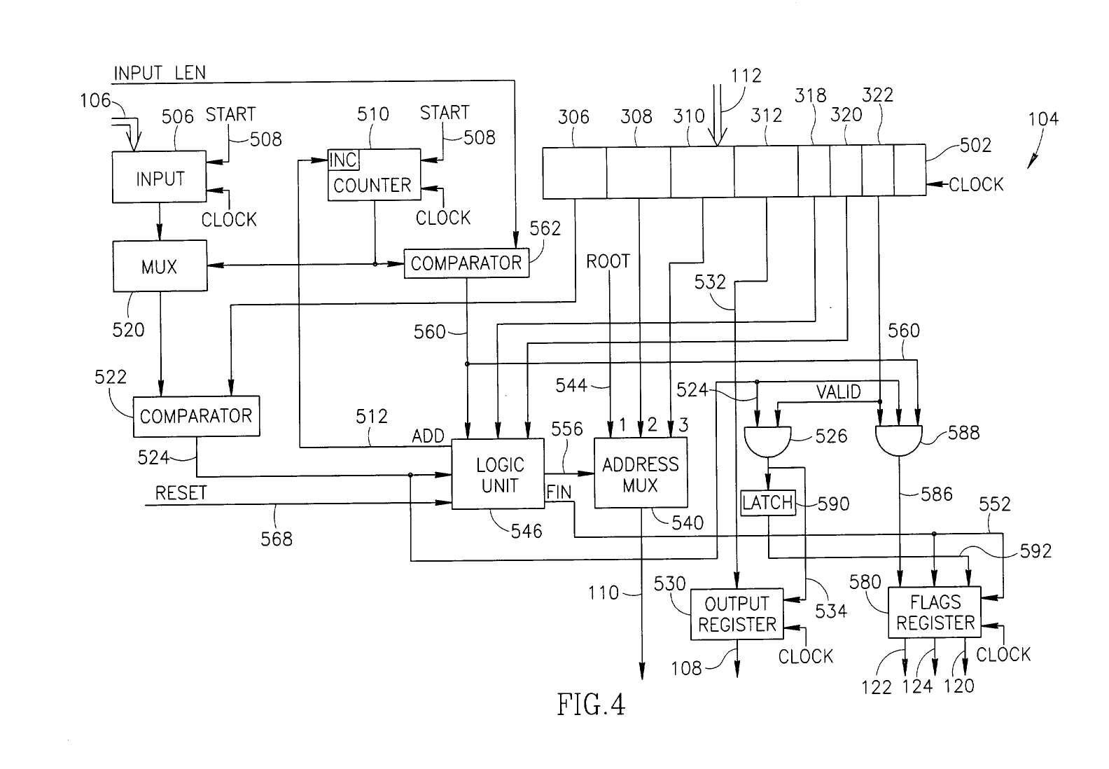

In some embodiments of the invention, a status field 314 includes validity bits 318, 320 and 322 (shown in FIG. 4) which indicate whether pointer fields 308, 310 and 312, respectively, are null. Alternatively or additionally to using one or more of validity bits 318, 320 and/or 322, one or more predetermined values (e.g., 0) are used to indicate null values in one or more of pointer fields 308, 310 and 312.

Referring to the exemplary records shown in FIG. 3, record 302A lists the value of node 204A (e.g., “Y”) in its value field 306 and the external pointer 208 of node 204A, representing the string “y”, in its external node field 312. As node 204A does not have child nodes, child pointer field 308 is null. Next record field 310 of record 302A includes the memory address of record 302B.

Record 302B lists the value of node 204B (e.g., “C”) in its value field 306 and the memory address of the record representing node 204D (the child of node 204B), e.g., 302D, in child pointer field 308. Next record field 310 of record 302B includes the memory address of record 302C. External node field 312 is optionally null as the string C is not represented by tree 200.

Record 302C lists the value of node 204C (e.g., “B”) in its value field 306 and the memory address of a first one of the records representing the child nodes of node 204C (e.g., 302E and 302F) in child pointer field 308. Next record field 310 of record 302C is null as root node 202 has no additional child nodes.

Record 302D lists the value of node 204D (e.g., “A”) in its value field 306. Child pointer field 308 points to the first of the records of the child nodes (204G and 204H) of node 204D (e.g., 302G). Next record field 310 lists a null value, as node 204D is the only child of node 204B.

FIG. 4 is a schematic block diagram of controller 104, in accordance with an embodiment of the present invention. Controller 104 optionally comprises an input register 506, which stores an input string received on input line 106. Optionally, an enable line of input register 506 receives a start signal 508, which is asserted (i.e., carries a set value) when a new string is to be read by controller 104. Controller 104 further comprises a record register 502, which stores current records received from memory 102 (FIG. 1) on data line 112. Record register 502 is optionally partitioned into the same fields as records 302, e.g., value field 306, child pointer field 308, next record field 310, external pointer field 312 and respective valid bits 318, 320 and 322. Alternatively to using a record register 502, the current record may be provided by other elements, for example, a latch or a direct line leading from memory 102.

A counter 510 optionally keeps track of a current position within the input string. Optionally, counter 510 is reset by start signal 508 to a value of 1, and is incremented responsive to an add signal on an add line 512, which is asserted on occasions described hereinbelow. In some embodiments of the invention, the output of counter 510 is input to a multiplexer 520, so as to select a current character from the input string provided by input register 506. The current character is optionally provided to a comparator 522, together with value field 306 from the current record in record register 502. Comparator 522 optionally provides a match signal line 524, which is asserted if the inputs of the comparator are equal.

Alternatively to using counter 510 and multiplexer 520, the input provided to controller 104 includes a single character and an interface (not shown) to controller 104 provides the correct character from the input string responsive to “add” indications from the controller. Optionally, in this alternative, the interface to controller 104 is responsible to indicate when the end of the string is reached.

An external pointer register 530 optionally stores a temporary result, i.e., an external pointer matching a largest encountered sub-string of the input string, which has a valid external pointer. To this effect, an input line 532 provides register 530 with the value of external pointer field 312 from record register 502. An enable line 534 causes register 530 to store the external pointer carried by input line 532, if the value on line 532 is valid (e.g., external pointer valid bit 322 of the record in register 502 is set) and match line 524 is asserted, i.e., the value field 306 of the current record matches the current value in the input string. The value in external pointer register 530 is optionally provided on output line 108. When the value on output line 108 is valid, output pointer valid line 120 is asserted. Alternatively, the value in external pointer register 530 is provided through an additional register or latch which provides the value only at the end of the tree search.

In some embodiments of the invention, controller 104 further includes a flag register 580, which provides as outputs output pointer valid line 120, full match line 122, and/or fin line 124 described above with reference to FIG. 1. Optionally, flag register 580 receives respective lines, i.e., a valid line 592 (corresponding to output pointer valid line 120), a full match line 586 (corresponding to full match line 122) and a fin line 552 (corresponding to output pointer valid line 120). In some embodiments of the invention, register 580 is enabled to lock its input values on lines 552, 586 and 592 responsive to fin line 552.

Fin line 552 is optionally generated by a logic unit 546, as described hereinbelow. Valid line 592 is optionally asserted if the output of “and” gate 526 was ever asserted during the search for the current input string through the tree. Optionally, a set-latch 590, which locks its input when the input is asserted, provides valid line 592. Alternatively or additionally, any other register or electrical element may be used instead of latch 590. In some embodiments of the invention, the contents of latch 590 is reset by start line 508.

Latch 590 is optionally enabled by the output of “and” gate 526, such that valid line 592 is asserted if during the current search an address was loaded into register 530. The contents of latch 590 are optionally cleared responsive to a start signal on line 508. Full match line 586 is optionally generated by an “and” gate 588 which receives external pointer valid bit 322, match line 524 and a last character line 560, which is asserted if the value in counter 510 is equal to the length of the input string. Optionally, a comparator 562 receives the length of the input string and the output of counter 510 and provides last character line 560 at its output.

Alternatively or additionally to generating valid line 592 by latch 590, status field 314 includes a flag (not shown) which indicates whether any of the records corresponding to ancestor nodes of the node corresponding to the record include a valid external pointer. If the flag is set, and fin line 552 is set without a match, then valid line 592 is not asserted, as no sub-string with a corresponding external pointer was encountered in the tree search.

An address multiplexer 540 optionally provides a next address to memory 102, on address bus 110. In some embodiments of the invention, multiplexer 540 receives a root address 544 of the tree (e.g., pointing to the first record in the database of the tree), the value of child pointer field 308 and the value of next record field 310. Logic unit 546 optionally provides a selection line 556 that determines which of the input addresses of multiplexer 540 is provided to address bus 110, as is now described.

In some embodiments of the invention, logic unit 546 receives match line 524, child valid bit 318, and next record valid bit 320. Optionally, logic unit 546 additionally receives last character line 560, which is asserted if the value in counter 510 is equal to the length of the input string. In some embodiments of the invention, logic unit 546 also receives a reset line 568. Optionally, logic unit 546 provides at its output add line 512, “fin” line 552, selection line 556 and full match line 580.

In some embodiments of the invention, the connection between the inputs and outputs of logic unit 546 is as described in table 1.

TABLE 1

| input lines | | | | | | | |
|---|---|---|---|---|---|---|---|
| | | child | next record | | output lines | | |
| reset | match | valid | valid | n = len | mux select | fin | add |
| 0 | 0 | x | 0 | x | 1(root) | 1 | 0 |
| 0 | 0 | x | 1 | x | 3(next) | 0 | 0 |
| 0 | 1 | x | x | 1 | 1(root) | 1 | 0 |
| 0 | 1 | 0 | x | 0 | 1(root) | 1 | 0 |
| 0 | 1 | 1 | x | 0 | 2(child) | 0 | 1 |
| 1 | x | x | x | x | 1(root) | 0 | 0 |

It is noted that the symbol “x” indicates that the value of the signal does not matter. The value of selection line 556 is “1” when the next address is the root address, “2” when the next address is from child pointer field 308 and “3” when the next address is from next record field 310.

In some embodiments of the invention, the value in register 530 is cleared at the beginning of each search, such that if no match is found, no address is provided. Alternatively or additionally, the value of counter 510 is provided as an output of controller 104. If the value of counter 510 is one when output pointer valid line 120 is asserted, the value on output line 108 is ignored.

In some embodiments of the invention, start line 508 is asserted when selection line 556 is “1” and an input string is awaiting a search.

In some embodiments of the invention, controller 104 and memory 102 are controlled by a clock signal provided by a clock generator (not shown), as is known in the art. Optionally, at each clock cycle memory 102 provides a record 302 to register 502. Optionally, an intermediate clock signal is provided to register 502 so as to lock the record 302 from memory 102 in the register. Alternatively, register 502 passes the record 302 from memory 102 into the elements of controller 104 without a controlling clock signal.

Optionally, the clock signal is also provided to input register 506, counter 510, flags register 580 and/or external pointer register 530. Alternatively or additionally, the clock signal is provided to one or more other elements and/or one or more additional intermediate clock signals are used to regulate the flow of signals within the controller and prevent overwriting of signals while the signals are still required. In some embodiments of the invention, controller 104 includes one or more additional registers which are used in regulating the flow of signals. For example, an address register controlling the output on address bus 108, may be used.

Following is an example search in the database of FIG. 3 for the string “CAB”, in accordance with an embodiment of the present invention. At a first clock cycle, the string “CAB” is loaded into input register 506, counter 510 is reset to 1, latch 590 is cleared and record 302A referenced by root address 544 is loaded into record register 502. Comparator 522 compares the first character of the input string, i.e., “C”, to the contents of value field 306 in record register 502, e.g., “Y”. Accordingly, match line 524 is “0”. As next record field 310 is not null, logic unit 546 provides a value of “3” on selection line 556. Accordingly, the address of record 302B is forwarded to address line 110 from next record field 310.

At a second clock cycle, record 302 B is loaded into record register 502. At this time, comparator 522 indicates a match and match line 524 is asserted. As the value of counter 510 is not equal to the length of the input string and child pointer field 308 is not null, logic unit 546 provides a value of “2” on selection line 556. Accordingly, the address of record 302D is forwarded to address bus 110. In addition, add line 512 is asserted. As external pointer field 312 is null, its value is not loaded to register 530 and the value in latch 590 remains “0”.

At a third clock cycle, record 302D is loaded into record register 502 and the value of counter 510 is incremented to two. The character “A” is provided by multiplexer 520 to comparator 522. Comparator 522 compares the character “A” to value field 306 in record register 502, and accordingly match line 524 is asserted. As the value of counter 510 is not equal to the length of the input string and child pointer field 308 is not null, logic unit 546 provides a value of “2” on selection line 556. Accordingly, the address of record 302G is forwarded to address bus 110. In addition, add line 512 is asserted. As external pointer field 312 is null, its value is not loaded to register 530 and the value in latch 590 remains “0”.

At a fourth clock cycle, record 302G is loaded into record register 502 and the value of counter 510 is incremented to three. The character “B” is provided by multiplexer 520 to comparator 522. Comparator 522 compares the character “B” to value field 306 in record register 502, and accordingly match line 524 is not asserted. As next record field 310 is not null, logic unit 546 provides a value of “3” on selection line 556, and the address of record 302H is forwarded to address bus 110.

At a fifth clock cycle, record 302H is loaded into record register 502. Comparator 522 compares the character “B” to value field 306 in record register 502, and accordingly match line 524 is not asserted. As next record field 310 is null, fin line 552 is asserted. Full match line 586 is not asserted as no match was found for the last character “B”. As no match with a corresponding external pointer was found along the search path, external pointer line 592 is not asserted. The values on lines 552, 586 and 592 are locked into flags register 580 and are provided respectively on lines 124, 122 and 120, as fin line 552 entering the enable of register 580 is asserted.

At a sixth clock cycle, record 302A referenced by root address 544 is loaded into record register 502. If a new string is awaiting a search, start line 508 is asserted and a new search is performed.

In some embodiments of the invention, the value of counter 510 is also provided as an output by controller 104, so as to notify the length of the string for which the external pointer was provided.

It is noted that the operations performed in each stage (i.e., clock cycle) by controller 104, are determined based on the contents of the record 302 currently in register 502, one or more input signals and the value in counter 510. Other than the value in counter 510, which points at the position in the input signal, controller 104 does not store an internal state that determines the operation of the controller, e.g., the next record 302 to be read. Controller 104 optionally does not receive a command which controls the operations performed by the controller.

It will be appreciated that the above described methods may be varied in many ways, including, performing a plurality of steps concurrently, changing the order of steps and changing the exact implementation used, for example “and” gate 588 may receive the output of “and” gate 526 instead of directly receiving line 524 and external bit 322. It should also be appreciated that the above described description of methods and apparatus are to be interpreted as including apparatus for carrying out the methods and methods of using the apparatus.

In some embodiments of the invention, μ-sequencer 100 is used for searching through a plurality of trees. In these embodiments, memory 102 optionally stores records of a plurality of trees. Optionally, each input string is received with an indication of the tree it is to be searched for in, and accordingly controller 104 determines the address of the first record to be fetched in the search. Alternatively or additionally, each input string is received with the address of the first record of the tree that is to be searched.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A hardware unit for searching through a tree, comprising:
a memory which stores a plurality of records, which describe the tree;
an input interface adapted to receive an input string to be searched for in the tree; and
a hardware controller, which does not store an internal state, other than an optional position in the input string, adapted to determine a pointer related to the input string, if such a pointer exists.

2. A hardware unit according to claim 1, wherein the controller does not receive multi-bit commands.

3. A hardware unit according to claim 1, wherein the controller does not receive memory-stored commands.

4. A hardware unit according to claim 1, wherein the plurality of records stored in the memory have the same length and field division.

5. A hardware unit according to claim 4, wherein the records include up to two pointer fields pointing to other records.

6. A hardware unit according to claim 4, wherein the records include a child pointer field and a next record field, pointing to a record having a common parent with the record including the next record field.

7. A hardware unit according to claim 4, wherein the records include up to three pointer fields to other records or to external points.

8. A hardware unit according to claim 1, wherein the controller determines a pointer corresponding to a string represented by the tree, which is identical to the input string.

9. A hardware unit according to claim 1, wherein the controller determines a pointer corresponding to a largest sub-string of the input string that has a corresponding external pointer.

10. A hardware unit according to claim 1, wherein except for a first record of the tree the controller fetches records from the memory using addresses contained in previously fetched records.

11. A hardware unit according to claim 1, wherein the controller comprises a multiplexer which provides addresses of records to be fetched from the tree and wherein the multiplexer has not more than four different input lines from which the addresses are selected.
